(19) United States
(12) Patent Application Publication
(10) Pub. No.: US 2026/0278106 A1
(43) Pub. Date: Sep. 17, 2026

(54) FULLY HOMOMORPHIC ENCRYPTION BOOTSTRAPPING SYSTEM AND METHOD

(71) Applicants: INVENTEC (PUDONG) TECHNOLOGY CORPORATION, Shanghai (CN); INVENTEC CORPORATION, Taipei City (TW)

(72) Inventors: Ming-Chien HO, Taipei City (TW); Yu-Te KU, Taipei City (TW); Chih-Fan HSU, Taipei City (TW); Ming-Ching CHANG, Taipei City (TW); Wei-Chao CHEN, Taipei City (TW); Feng-Hao LIU, Taipei City (TW); Yu HSIAO, Taipei City (TW); Shih-Hao HUNG, Taipei City (TW)

(73) Assignees: INVENTEC (PUDONG) TECHNOLOGY CORPORATION, Shanghai (CN); INVENTEC CORPORATION, Taipei City (TW)

(21) Appl. No.: 19/319,493

(22) Filed: Sep. 4, 2025

(30) Foreign Application Priority Data
Mar. 17, 2025 (CN) 202510310106.X

(51) Int. Cl. G06F 21/57; H04L 9/00

(52) U.S. Cl. CPC G06F 21/575; H04L 9/008; G06F 2221/034

(57) ABSTRACT

A fully homomorphic encryption bootstrapping system and method are proposed. The method includes the following steps performed by a computing device: performing a large-number decomposition on an original ciphertext to generate two first ciphertexts, wherein a coefficient of the two first ciphertexts is smaller than a coefficient corresponding to the original ciphertext, sequentially performing a gadget decomposition, a fast Fourier transform, a polynomial operation, and an inverse fast Fourier transform on the two first ciphertexts to generate two second ciphertexts; and merging the two second ciphertexts to generate an output result, wherein a coefficient range of any one of the two second ciphertexts is smaller than a coefficient range of the output result.

### CROSS-REFERENCE TO RELATED APPLICATIONS

This non-provisional application claims priority under 35 U.S.C. § 119(a) on Patent Application No(s). 202510310106.X filed in China on Mar. 17, 2025, the entire contents of which are hereby incorporated by reference.

### BACKGROUND

### 1. Technical Field

The present disclosure relates fully homomorphic encryption, and more particularly to a fully homomorphic encryption bootstrapping system and method.

### 2. Related Art

Fully Homomorphic Encryption (FHE) is a cryptographic technique that enables computations to be performed on encrypted data without the need for decryption. FHE is widely applied in areas such as cloud computing, machine learning, and privacy-preserving data analysis. The third-generation FHE schemes, commonly known as FHEW/TFHE, offer more lightweight parameters (such as ciphertext modulus and secret keys) and smaller modulus-to-noise ratio compared to earlier schemes, making them more resilient to both classical and quantum attacks.

Bootstrapping is a crucial operation in FHEW/TFHE, primarily used to reduce the noise within ciphertexts to ensure that further encrypted computations remain feasible. However, bootstrapping is also the most time-consuming operation among all ciphertext computations. When the ciphertext modulus is not large (e.g., less than 2⁶⁰), bootstrapping may be 1,000 to 10,000 times slower than ciphertext addition, 1,000 times slower than encryption, and 10,000 times slower than decryption. During the bootstrapping process, ciphertexts are represented as polynomials over rings with integer coefficients and involve extensive polynomial arithmetic. The size of these coefficients is affected by the ciphertext modulus, so as the modulus increases, the associated large-coefficient polynomial operations become more complex.

However, in high-precision computing or large-number numerical analysis, FHEW/TFHE schemes often require larger ciphertext moduli. Currently, the fastest known library, TFHE-rs, does not support ciphertext moduli beyond 2⁶⁴. The widely used OpenFHE library relies on 128-bit integers to perform polynomial operations when the modulus exceeds 2⁶⁰, which is inefficient on conventional 64-bit computing architectures and further exacerbates the already slow bootstrapping performance.

### SUMMARY

In view of the above, the present disclosure provides a fully homomorphic encryption bootstrapping system and method that addresses these limitations.

According to one or more embodiment of the present disclosure, a fully homomorphic encryption bootstrapping method is performed by a computing device and includes the following steps: performing a large-number decomposition on an original ciphertext to generate two first ciphertexts, wherein a coefficient corresponding to the two first ciphertexts is smaller than a coefficient corresponding to the original ciphertext; sequentially performing a gadget decomposition, a fast Fourier transform, a polynomial operation, and an inverse fast Fourier transform on the two first ciphertexts to generate two second ciphertexts; and merging the two second ciphertexts to generate an output result, wherein a coefficient range of any one of the two second ciphertexts is smaller than a coefficient range of the output result.

According to one or more embodiment of the present disclosure, a fully homomorphic encryption bootstrapping system includes a storage device and a computing device. The storage device is configured to store an original ciphertext and a plurality of instructions. The computing device is electrically connected to the storage device. The computing device is configured to execute the plurality of instructions to perform a plurality of operations, and the plurality of operations comprises: obtaining the original ciphertext from the storage device and performing a large-number decomposition on the original ciphertext to generate two first ciphertexts, wherein a coefficient corresponding to the two first ciphertexts is smaller than a coefficient corresponding to the original ciphertext; sequentially performing a gadget decomposition, a fast Fourier transform, a polynomial operation, and an inverse fast Fourier transform on the two first ciphertexts to generate two second ciphertexts; and merging the two second ciphertexts to generate an output result, wherein a coefficient range of any one of the two second ciphertexts is smaller than a coefficient range of the output result.

In summary, considering both lightweight implementation and security, the present disclosure improves upon existing FHEW/TFHE schemes by proposing a bootstrapping system and method that supports large ciphertext moduli (for example, ciphertext modulus greater than 2⁶⁰). This addresses the limitations of current libraries that either do not support large ciphertext moduli or suffer from significantly reduced computational efficiency.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a block diagram of a fully homomorphic encryption bootstrapping system according to an embodiment of the present disclosure;

FIG. 2 is a flowchart illustrating a fully homomorphic encryption bootstrapping method according to an embodiment of the present disclosure;

FIG. 3 is a flowchart illustrating a fully homomorphic encryption bootstrapping method according to another embodiment of the present disclosure; and

FIG. 4 is a graph showing the relationship between the base used for large-number decomposition and the second error.

### DETAILED DESCRIPTION

In the following detailed description, for purposes of explanation, numerous specific details are set forth in order to provide a thorough understanding of the disclosed embodiments. According to the description, claims and the drawings disclosed in the specification, one skilled in the art may easily understand the concepts and features of the present disclosure. The following embodiments further illustrate various aspects of the present disclosure, but are not meant to limit the scope of the present disclosure.

Table 1 below lists the abbreviations used in this disclosure, along with their full names and descriptions.

TABLE 1

| Abbreviation | Full Name | Description |
|---|---|---|
| FFT | Fast Fourier Transform | Fast Fourier Transform |
| iFFT | Inverse Fast Fourier Transform | Inverse Fast Fourier Transform |
| NTT | Number Theoretic Transform | Number Theoretic Transform |
| LWE | Learn With Error | Learn With Error |
| RLWE | Ring Learning With Errors | Ring Learning With Errors |
| GINX | Gama-Izabachene-Nguyen-Xie | A bootstrapping method |

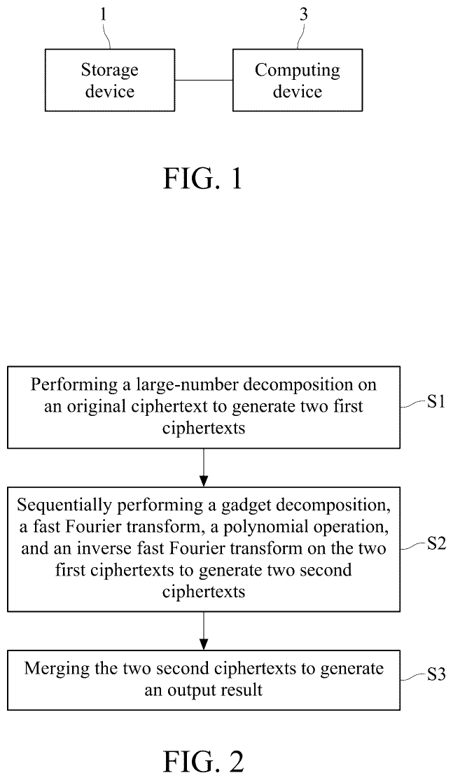

FIG. 1 is a block diagram of a fully homomorphic encryption bootstrapping system according to an embodiment of the present disclosure. As shown in FIG. 1, the bootstrapping system includes a storage device 1 and a computing device 3.

The storage device 1 is configured to store an original ciphertext, a ciphertext modulus, and a plurality of instructions. The ciphertext modulus is greater than 2⁶⁰. In an embodiment, the storage device 1 may adopt at least one of the following examples: flash memory, hard disk drive (HDD), solid-state drive (SSD), dynamic random-access memory (DRAM), static random-access memory (SRAM), or other types of non-volatile memory. However, the present disclosure is not limited to any specific type of hardware for implementing the storage device 1.

The computing device 3 is electrically connected to the storage device 1. The computing device 3 is configured to execute the plurality of instructions to perform a plurality of operations, and the plurality of operations includes: obtaining the original ciphertext from the storage device and performing a large-number decomposition on the original ciphertext to generate two first ciphertexts, wherein a coefficient corresponding to the two first ciphertexts is smaller than a coefficient corresponding to the original ciphertext; sequentially performing a gadget decomposition, a fast Fourier transform, a polynomial operation, and an inverse fast Fourier transform on the two first ciphertexts to generate two second ciphertexts; and merging the two second ciphertexts to generate an output result. In an embodiment, the computing device 3 may adopt at least one of the following examples: a personal computer, a network server, a central processing unit (CPU), a graphics processing unit (GPU), a microcontroller, an application processor, a field-programmable gate array (FPGA), an application-specific integrated circuit (ASIC), a system on chip (SoC), a deep learning accelerator, or any electronic device with similar functionality. However, the present disclosure is not limited to any specific type of hardware for implementing the computing device 3.

FIG. 2 is a flowchart illustrating a fully homomorphic encryption bootstrapping method according to an embodiment of the present disclosure. As shown in FIG. 2, the bootstrapping method includes steps S1 to S3.

Step S1: The computing device 3 obtains an original ciphertext from the storage device 1 and performs a large-number decomposition on the original ciphertext to generate two first ciphertexts. This step may be represented as [symbol] (ct)=(ct₀, ct₁), where [symbol] (⋅) denotes the large-number decomposition function, ct denotes the original ciphertext, and ct₀, ct₁ are the two resulting first ciphertexts.

The structure of the original ciphertext follows the RLWE format and consists of two polynomials, as follows:

$$ct = ( c , d )$$

The two first ciphertexts are as follows:

$${ct}_{0} = ( {c}_{0} , {d}_{0} ) , {ct}_{1} = ( {c}_{1} , {d}_{1} )$$

The decomposition function [symbol] satisfies:

$$c = {{\sum }_{i = 0}}^{1} {c}_{i} {\overline{B}}^{i} , d = {{\sum }_{i = 0}}^{1} {d}_{i} {\overline{B}}^{i}$$

The purpose of the large-number decomposition is to break down a polynomial with large coefficients into multiple polynomials with smaller coefficients. The base B̅ controls the range of these smaller coefficients. Therefore, the coefficients corresponding to the two first ciphertexts are smaller than those of the original ciphertext.

Step S2: The computing device 3 sequentially performs Gadget decomposition, FFT, polynomial operations, and iFFT on the two first ciphertexts to generate two second ciphertexts. Step S2 is repeated n times before proceeding to step S3, where n is the dimension of the polynomial in the LWE ciphertext. Each Gadget decomposition uses the result of the previous round to ensure that the subsequent FFT, polynomial operations, and iFFT may effectively reduce the ciphertext noise.

In step S2, for performance optimization, the present disclosure uses FFT instead of the NTT (Number Theoretic Transform) used in the OpenFHE library. In general, for hardware implementations, since NTT involves modular operations with special prime moduli, it incurs higher computational cost than FFT, even though both support SIMD instruction-based computation. Furthermore, FFT benefits from more advanced algorithmic optimizations and thus runs faster than NTT. However, FFT relies on IEEE 754 floating-point arithmetic, which can result in precision loss when processing large values. To mitigate this, the base B̅ is used in step S1 to control the coefficient range of each polynomial so that the resulting product coefficients remain bounded, thereby reducing FFT-induced precision loss.

During the polynomial operations in step S2, many small-coefficient polynomials are multiplied with each other. This process has the following property: when two polynomials a and b are multiplied, the operation is expressed as a×b, where b is the output of Gadget decomposition; the coefficient range of b is limited by the base B of the Gadget decomposition; and therefore, if an appropriate B̅ is chosen such that B̅>B, only the large-coefficient polynomial a needs to be decomposed, which reduces the total number of polynomials to be decomposed.

For example, if a is decomposed into two small-coefficient polynomials a₀, a₁, the multiplication of the two polynomials may be represented as follows:

$$a \times b = {c}_{0} + {c}_{1} \times \overline{B}$$

where c₀=a₀×b, c₁=a₁×b

The precision loss of a×b may be represented as:

$$⌈ {S}_{0} ϵ ⌋ + ⌈ {S}_{1} ϵ ⌋ \times \overline{B}$$

where ε denotes a relative error, which is related to the polynomial dimension and the FFT library. Specifically, ε is proportional to \sqrt{log N}, i.e., ε~k×\sqrt{log N}, where k is a constant influenced by the implementation of the FFT library.
┌⋅┐ denotes rounding to the nearest integer. S₀ is the coefficient range of c₀, S₁ is the coefficient range of c₁, and they satisfies:

$${S}_{0} = \frac{B \times \overline{B} \times \sqrt{N}}{4} , {S}_{1} = \frac{B \times \frac{Q}{\overline{B}} \times \sqrt{N}}{4}$$

From the above, it is evident that the precision loss caused by c₁ has the greatest impact on the overall computation. Therefore, choosing an appropriate B̅ such that S₁ε<0.5 may reduce the total precision loss to only ┌S₀ε┐.

Step S3: The computing device 3 merges the two second ciphertexts to generate an output result. This step can be expressed as C(ct₀, ct₁)=ct, where C(⋅) denotes the merging function, ct₀, ct₁ are the two second ciphertexts, and ct is the output result. The merging process satisfies:

$${ct}_{0} = ( {c}_{0} , {d}_{0} ) , {ct}_{1} = ( {c}_{1} , {d}_{1} ) , ct = ( c , d ) ,$$

$$c = {{\sum }_{i = 0}}^{1} {c}_{i} {\overline{B}}^{i} , d = {{\sum }_{i = 0}}^{1} {d}_{i} {\overline{B}}^{i}$$

From the above, it is evident that the coefficient range of either of the second ciphertexts is smaller than that of the output ciphertext. For example, if the coefficient range of c is

$$[ - \frac{Q}{2} , \frac{Q}{2} ] ,$$

then the coefficient range of c₀ is

$$[ - \frac{\overline{B}}{2} , \frac{\overline{B}}{2} ] ,$$

and that of c₁ is

$$[ - \frac{Q}{2 \overline{B}} , \frac{Q}{2 \overline{B}} ] .$$

In summary, the present disclosure integrates FFT-based polynomial multiplication into the bootstrapping computation. Compared with the conventional process, the embodiment shown in FIG. 2 adds two extra steps: step S1 (Large-number decomposition) and step S3 (RLWE ciphertext reassembly). These two steps enable bootstrapping under large ciphertext modulus.

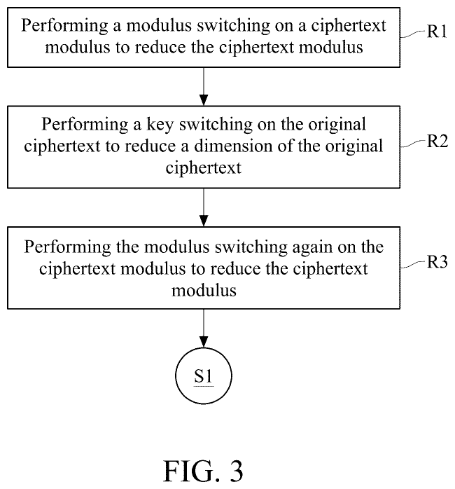

FIG. 3 is a flowchart illustrating a fully homomorphic encryption bootstrapping method according to another embodiment of the present disclosure. As shown in FIG. 3, before performing step S2 to generate the two first ciphertexts, steps R1 to R3 are performed. In step R1, the computing device 3 performs a modulus switching on a ciphertext modulus to reduce the ciphertext modulus, for example, reducing from Q to Qₖₛ. In step R2, after the ciphertext modulus is reduced, the computing device 3 performs a key switching on the original ciphertext to reduce its dimension, for example, from N to n. In step R3, after reducing the dimension of the original ciphertext, the computing device 3 again performs the modulus switching on the ciphertext modulus to reduce the ciphertext modulus, for example, from Qₖₛ to q.

It is important to note that in the prior art, steps R1 to R3 are usually performed after step S2 in FIG. 2. However, in the present disclosure, to take advantage of using a large ciphertext modulus, the bootstrapping flow is adjusted such that the ciphertext entering the flow of FIG. 2 already possesses the larger modulus Q.

Because the present disclosure provides the two embodiments shown in FIG. 2 and FIG. 3, it is necessary to evaluate the errors in the ciphertext both before and after entering the FIG. 2 process. These errors may be modeled as Gaussian standard deviations.

The accumulated noise from computation on the original ciphertext, the noise introduced by the modulus switching, and the noise introduced by the key switching may all be modeled as Gaussian distributions. In said another embodiment, since the ciphertext passes through the flow shown in FIG. 3 before entering that of FIG. 2, in addition to the accumulated computation error σ_{arithmetic}, there are also two modulus-switching errors σ_{MS1}, σ_{MS2}, and a key-switching error OKs. Therefore, before entering the process shown in FIG. 2, a first error β₁ is as follows:

$$β = \sqrt{\frac{{q}^{2}}{{Q}_{ks}^{2}} ( \frac{{Q}_{ks}^{2}}{{Q}^{2}} {σ}_{arithmetic}^{2} + {σ}_{MS 1}^{2} + {σ}_{KS}^{2} ) + {σ}_{MS 2}^{2}}$$

On the other hand, under the premise of a large ciphertext modulus and high computational efficiency, the precision loss caused by FFT cannot be ignored. Therefore, the present disclosure improves the error estimation method used in bootstrapping operations to help users determine the optimal FHE parameters. After completing the process shown in FIG. 2, a second error β₂ may be modeled as a Gaussian standard deviation, as follows:

$${β}_{Boots} = {σ}_{GINX} + {Δ}_{FFT}$$

where σ_{GNIX} is the error generated by the algorithm used in step S2, and Δ_{FFT} is the error introduced by FFT, as follows:

$${Δ}_{FFT} = \vert ( 1 - ‖ {s}_{N} ‖ ) {e}_{fft} \vert , ‖ {s}_{N} ‖ \leq \sqrt{\frac{N}{2}}$$

where e_{fft} denotes the precision loss from polynomial multiplication, as follows:

$${e}_{fft} = \sqrt{n} ( ⌈ 2 \sqrt{{d}_{g}} {S}_{0} ϵ ⌋ + ⌈ 2 \sqrt{{d}_{g}} {S}_{1} ϵ ⌋ \overline{B} )$$

where S₀, S₁ represent the precision loss resulting from decomposing the polynomial a into two small-coefficient polynomials a₀, a₁, respectively. Their calculation methods can be found in the formulas listed previously. Therefore, when 2\sqrt{d_{g}}S₁ε<0.5, e_{fft} is reduced to \sqrt{n}|2\sqrt{d_{g}}S₀ε┐.

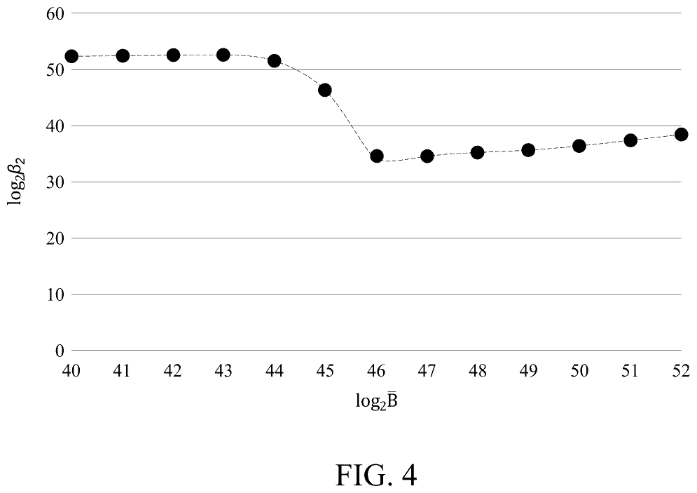

FIG. 4 is a graph showing the relationship between the base used for large-number decomposition and the second error. As shown in FIG. 4, when B̅>BQε\sqrt{d_{g}N}, β₂ significantly decreases, where N denotes the dimension of the second ciphertext, B denotes the base used in the Gadget decomposition, Q denotes the modulus of the first ciphertext, ε denotes the relative error, and d_{g} denotes the decomposition count in the Gadget decomposition.

Overall, to support ciphertext moduli greater than 2⁶⁰, the present disclosure first accelerates polynomial operations in step S1 through the large-number decomposition and integrates the decomposition results into step S2. To prevent decryption failure due to excessive noise after bootstrapping, it is necessary to appropriately control precision loss. Since step S2 involves a large number of multiplications in the ring of integer-coefficient polynomials, and the polynomial coefficient ranges are related to the ciphertext modulus, choosing an appropriate B̅ is crucial for computational accuracy.

Table 2 compares the computation time between the present disclosure and conventional techniques under different modulus settings. The experimental environment is configured as follows: the implementation is based on OpenFHE, compiled using g++ 11.4 with the −ffast-math flag and OpenFHE configured with NATIVE_SIZE=128. OpenMP 4.5 is used for parallelization, and FFTW v3.3.10 is used for the FFT implementation. The hardware is a 32-core AMD Ryzen Threadripper PRO 5975WX with 256 GB of RAM, running Ubuntu 22.04.2 LTS. The computation time is measured using the EvalFunc function. EvalFunc is a function supported by OpenFHE and is composed of two bootstrapping operations.

TABLE 2

| Method | log₂Q | d_{g} | log₂B̅ | log₂β_{std} | 1T(s) | 32T(s) |
|---|---|---|---|---|---|---|
| OpenFHE | 62 | 3 | N/A | 33 | 7.92(1X) | 0.28(1X) |
| The present disclosure | 62 | 3 | 44 | 33 | 0.97(8.2X) | 0.04(7X) |
| The present disclosure | 62 | 4 | 44 | 29 | 1.17(6.7X) | 0.05(5.6X) |
| OpenFHE | 64 | 3 | N/A | 34 | 8.24(1X) | 0.28(1X) |
| The present disclosure | 64 | 3 | 44 | 34 | 0.98(8.4X) | 0.04(7X) |
| The present disclosure | 64 | 4 | 44 | 29 | 1.25(6.6X) | 0.05(5.6X) |
| OpenFHE | 66 | 3 | N/A | 35 | 8.54(1X) | 0.29(1X) |
| The present disclosure | 66 | 3 | 46 | 35 | 0.95(9X) | 0.04(7.3X) |
| The present disclosure | 66 | 4 | 46 | 30 | 1.23(6.9X) | 0.05(5.8X) |
| OpenFHE | 68 | 3 | N/A | 35 | 8.53(1X) | 0.29(1X) |
| The present disclosure | 68 | 3 | 49 | 36 | 0.97(8.8X) | 0.04(7.3X) |
| The present disclosure | 68 | 4 | 49 | 31 | 1.13(7.5X) | 0.05(5.8X) |
| OpenFHE | 70 | 3 | N/A | 36 | 8.53(1X) | 0.29(1X) |
| The present disclosure | 70 | 3 | 52 | 40 | 0.97(8.8X) | 0.04(7.3X) |
| The present disclosure | 70 | 4 | 52 | 34 | 1.12(7.6X) | 0.05(5.8X) |
| OpenFHE | 72 | 3 | N/A | 37 | 8.55(1X) | 0.29(1X) |
| The present disclosure | 72 | 3 | 54 | 42 | 0.95(9X) | 0.04(7.3X) |
| The present disclosure | 72 | 4 | 53 | 36 | 1.11(7.7X) | 0.05(5.8X) |
| OpenFHE | 74 | 3 | N/A | 37 | 8.55(1X) | 0.29(1X) |
| The present disclosure | 74 | 3 | 57 | 46 | 0.97(8.8X) | 0.04(7.3X) |
| The present disclosure | 74 | 4 | 53 | 36 | 1.18(7.2X) | 0.05(5.8X) |
| OpenFHE | 76 | 3 | N/A | 38 | 8.52(1X) | 0.29(1X) |
| The present disclosure | 76 | 3 | 61 | 51 | 0.97(8.8X) | 0.04(7.3X) |
| The present disclosure | 76 | 4 | 54 | 38 | 1.18(7.2X) | 0.05(5.8X) |

As shown in Table 2, under different modulus values Q and with the same noise level β_{std}, the present disclosure achieves a 7 to 8 times speedup using a single thread (1T), and a 5 to 7 times speedup using multiple threads (32T).

In summary, considering both lightweight implementation and security, the present disclosure improves upon existing FHEW/TFHE schemes by proposing a bootstrapping system and method that supports large ciphertext moduli. This addresses the limitations of current libraries that either do not support large ciphertext moduli or suffer from significantly reduced computational efficiency. The present disclosure can be applied to embedded systems that only support small bit-widths (e.g., int16). Through the proposed method, larger moduli (e.g., int32) can be supported under lightweight and high-performance conditions, thereby achieving the effect of large modulus encryption. In the future, when AI models require encryption of wide-range numerical data (such as astronomical data), the present disclosure may be used to increase the modulus size, enabling the encryption of larger plaintexts and further expanding the practical application scope of fully homomorphic encryption in data privacy protection.

What is claimed is:

1. A fully homomorphic encryption bootstrapping method, performed by a computing device, comprising:
performing a large-number decomposition on an original ciphertext to generate two first ciphertexts, wherein a coefficient corresponding to the two first ciphertexts is smaller than a coefficient corresponding to the original ciphertext;
sequentially performing a gadget decomposition, a fast Fourier transform, a polynomial operation, and an inverse fast Fourier transform on the two first ciphertexts to generate two second ciphertexts; and
merging the two second ciphertexts to generate an output result, wherein a coefficient range of any one of the two second ciphertexts is smaller than a coefficient range of the output result.

2. The fully homomorphic encryption bootstrapping method of claim 1, before generating the two first ciphertexts, further comprising:
performing a modulus switching on a ciphertext modulus to reduce the ciphertext modulus, wherein the ciphertext modulus is greater than 2⁶⁰;
performing a key switching on the original ciphertext to reduce a dimension of the original ciphertext after the ciphertext modulus is reduced; and
performing the modulus switching again on the ciphertext modulus to reduce the ciphertext modulus after the dimension of the original ciphertext is reduced.

3. The fully homomorphic encryption bootstrapping method of claim 1, wherein a base of the large-number decomposition is denoted as B̅, and B̅>BQε\sqrt{d_{g}N}, wherein B denotes a base of the gadget decomposition, Q denotes a modulus of the two first ciphertexts, ε denotes a relative error, d_{g} denotes a number of decompositions in the gadget decomposition, and N denotes a dimension of the two second ciphertexts.

4. A fully homomorphic encryption bootstrapping system comprising:
a storage device configured to store an original ciphertext and a plurality of instructions; and
a computing device electrically connected to the storage device, wherein the computing device is configured to execute the plurality of instructions to perform a plurality of operations, and the plurality of operations comprises: obtaining the original ciphertext from the storage device and performing a large-number decomposition on the original ciphertext to generate two first ciphertexts, wherein a coefficient corresponding to the two first ciphertexts is smaller than a coefficient corresponding to the original ciphertext; sequentially performing a gadget decomposition, a fast Fourier transform, a polynomial operation, and an inverse fast Fourier transform on the two first ciphertexts to generate two second ciphertexts; and merging the two second ciphertexts to generate an output result, wherein a coefficient range of any one of the two second ciphertexts is smaller than a coefficient range of the output result.

5. The fully homomorphic encryption bootstrapping system comprising of claim 4, wherein the storage device is further configured to store a ciphertext modulus greater than 2⁶⁰, and the plurality of operations further comprises: performing a modulus switching on the ciphertext modulus to reduce the ciphertext modulus; performing a key switching on the original ciphertext to reduce a dimension of the original ciphertext after the ciphertext modulus is reduced; and performing the modulus switching again on the ciphertext modulus to reduce the ciphertext modulus after the dimension of the original ciphertext is reduced.

6. The fully homomorphic encryption bootstrapping system comprising of claim 4, wherein a base of the large-number decomposition is denoted as B̅, and B̅>BQεd̅_̅{̅g̅}̅N̅, wherein B denotes a base of the gadget decomposition, Q denotes a modulus of the two first ciphertexts, ε denotes a relative error, d_{g} denotes a number of decompositions in the gadget decomposition, and N denotes a dimension of the two second ciphertexts.
